(19) United States
(12) Patent Application Publication
(10) Pub. No.: US 2024/0359098 A1
(43) Pub. Date: Oct. 31, 2024

(54) Method Of Producing A Video Game Environment

(71) Applicant: Sony Interactive Entertainment Europe Limited, London (GB)

(72) Inventors: Lewis Barn, London (GB); Lewis Thresh, London (GB); Michael Eder, London (GB)

(73) Assignee: Sony Interactive Entertainment Europe Limited, London (GB)

(21) Appl. No.: 18/645,964

(22) Filed: Apr. 25, 2024

(30) Foreign Application Priority Data
Apr. 25, 2023 (GB) GB2306005.6

(51) Int. Cl. A63F 13/54; A63F 13/52; A63F 13/5372

(52) U.S. Cl. CPC A63F 13/54; A63F 13/52; A63F 13/5372

(57) ABSTRACT

A computer-implemented method of producing a video game environment. The method comprises receiving a representation of the video game environment, identifying a first object in the video game environment, and identifying, based on a graphical representation of the first object, one or more properties of the first object suitable for selecting a sound effect to be applied to the first object. A sound effect is applied to the first object in the video game environment based on the one or more identified properties.

### CROSS-REFERENCE TO RELATED APPLICATION

The present application claims priority from United Kingdom Patent Application No. GB2306005.6, filed Apr. 25, 2023, the disclosure of which is hereby incorporated herein by reference.

### FIELD OF THE INVENTION

This invention relates to methods of producing video game environments. In particular, the invention relates to improvements in adding sound effects to video game environments.

### BACKGROUND

Many video games employ graphics and sound to create immersive virtual environments. As a player explores and interacts with the game world, they will expect to hear different sounds with objects in the world: for example, as the player controls their character to run across a stone floor, the player might hear the sound of footsteps on such a floor. If the character then crosses onto a wooden surface, the sound will change to one representing the sound of footsteps on wood. Ambient sounds may also be associated with associated with objects throughout the world: for example, the player may hear the sound of water flowing when near a stream.

Associating sound effects with objects in the game world is a major task in the production of video game environments. Conventionally, a graphics artist produces a graphical model of the environment, possibly including tags identifying the materials of the objects in the environment, and then a sound designer manually adds suitable sound effects to the objects. For example, the sound designer might identify that a door is made of wood (based on either a tag provided by the graphics artist or manual inspection) and then select suitable sound effects for particular kinds of interaction with the door (such as a bullet hitting the door or the player's character colliding with the door) based on its material. The sound designer's task of associating sound effects with objects in the game world is extremely time-consuming, particularly in large, detailed game environments. This ultimately limits the size and richness of video game environments that can feasibly be developed. There is hence a need for a way of reducing the time taken to produce video game environments.

### SUMMARY

The invention provides a computer-implemented method of producing a video game environment, the method comprising:
receiving a representation of the video game environment;
identifying a first object in the video game environment;
identifying, based on a graphical representation of the first object, one or more properties of the first object suitable for selecting a sound effect to be applied to the first object; and
applying a sound effect to the first object in the video game environment based on the one or more identified properties.

The video game environment will typically constitute a portion of a larger game world and could be, for example, the setting of a level in the game such as a room or building. The representation of this environment could be any data that represents the video game environment: for example, it could be a graphical representation of the video game environment such as a graphical model produced by a graphics artist (e.g. in the form of an FBX or .maya file) or photogrammetric model, an image (e.g. a screenshot) of such a model, or a sketch or other artwork representing the intended design of the video game environment. It could also be a non-graphical representation of the environment—e.g. code defining the form of the environment (e.g. terrain) and objects in the environment. The video game environment contains objects, e.g. doors, walls and furniture, which are identified in the graphical representation. Properties of the identified objects, e.g. material and dimensions, are identified based on a graphical representation of the identified first object (for example, the material of the object could be determined from the pattern in which it is rendered) such that suitable sound effects can ultimately be associated with those objects. For example, the identified first object could be a door and one of the identified properties of that object could be that it is made of wood. Based on this information, sound effects representing interactions with a wooden object—e.g. a bullet hitting wood-could be associated with the object such that they are played when the player interacts with it during gameplay. This method thus achieves automated identification of objects and their properties which ultimately facilitates the application of suitable sound effects to the objects in the game environment. This saves the sound developer significant time compared to the conventional approach of adding sounds based on manual inspection of the environment.

It will be appreciated that the analysis may identify a plurality of objects (of which the first object is only one), in which case properties of each of the plurality of objects may be identified based on the representation and one or more sound effects applied to each object based on its respective identified properties.

It will be appreciated that the graphical representation of the first object could be part of the representation of the representation of the video game environment. The two representations could even be the same: for example, a screenshot of the part of the environment that contains the first object could serve as the representation of the video game environment in which the first object is identified, and properties of the first object (e.g. its material) could be identified from the same graphical representation. The graphical representation of the first object could be different from the representation of the video game environment, however: for example, after identifying the first object in the video game environment, a graphical representation comprising a more detailed view of the first object could be provided.

In some preferred embodiments, the sound effect applied to the first object is selected and applied automatically based on the one or more identified properties. For example, it may be identified that an object is made of wood based on the texture in which it appears in the graphical representation, based on which a sound effect representing an interaction with a wooden object may be selected for that object.

In other preferred implementations, the method further comprises, after identifying the one or more properties of the first object, applying a tag to the first object, the tag comprising information identifying the one or more identified properties. The provision of tags identifying the properties of the objects allows sounds to be easily implemented (either by the sound designer or automatically) and therefore improves the speed of production relative to the conventional approach. It should be appreciated that, while the sound effect is ultimately applied to the object by the computer as part of the computer-implemented method, the sound effect may be applied to the first object in response to user input indicating a selection of the sound effect. Alternatively, the sound effect may be implemented automatically, by the computer, based on the information identifying the one or more identified properties that is comprised by the tag. In this case, the implementation of the sound effect is fully automated and does not require any user input.

Applying the sound effect to the first object may comprise implementing the sound effect in the video game environment such that the sound effect is played upon interaction with the first object by a player. This could involve for example adding the sound effect to the data files that constitute the video game software such that it is activated when the player interacts with the object during gameplay. For example, if the first object is a door, a sound effect representing the sound of the door opening could be played when the player opens the door. In another example, if the first object is a source of ambient sound such as a stream, the sound effect could be played in response to the player being within a specified distance of the object. It will be recognised that this results in the video game environment being configured to play the sounds effects associated with objects as the player interacts with those objects during gameplay. As an example of such a manner of implementing the sound effect, in some implementations, applying the sound effect to the first object in the video game environment based on the one or more identified properties may comprise generating a file configured to cause the sound effect to be played in response to the player interacting with the object during gameplay. This file could be added to the data files of the video game software discussed previously.

The sound effect is preferably selected from a sound effect library. This further facilitates the automation of the task of sound design since the computer can easily select the sounds from the library. Preferably, the sound effect library comprises a plurality of sound effects and, for each sound effect, one or more properties associated with the sound effect. Sound effects suitable for application to the identified first object can thus easily be selected by looking for sound effects in the sound effect library that are labelled with the same or similar properties. Therefore, advantageously, the sound effect applied to the first object may be selected from the sound effect library based on a match between at least one of the one or more identified properties and the properties associated with the sound effect in the sound effect library.

Preferably, the identified properties comprise one or more of a material of the first object, one or more dimensions of the first object, and an action to be performed by the first object during gameplay. These are examples of properties that can be identified by analysis of a graphical representation of an environment. For example, the material could be identified by the visual texture in which the object is rendered in the graphical representation. The dimensions of the object may be relevant to the sound effect to be associated with it because differently-sized objects of the same material may be expected to produce different sounds when interacted with—for example, a small window breaking might make a different sound to a larger one. Actions to be performed by the object that can be identified from visual analysis can include, for example, a door opening.

Advantageously, the identification of the one or more properties of the first object is performed using a computer vision algorithm. Computer vision algorithms are a class of machine learning algorithm adapted to classify images and can therefore be trained to recognise objects in graphical representations of objects in video game environments. Examples of suitable computer vision algorithms suitable for recognising objects include SIFT, SURF and YOLO. Preferably, the computer vision algorithm is trained, prior to the analysis, on graphical representations of objects other than the first object. For example, the algorithm could be trained using a mixture of screenshots of video game environments containing objects and images of individual objects.

In preferred embodiments, the method further comprises: automatically analysing the representation of the video game environment to identify a second object in the video game environment; detecting a failure in identifying one or more properties of the second object; and outputting a flag indicating the failure. Providing a flag indicating that the computer has not been able to identify any properties of the second object suitable for selecting a sound effect is beneficial as it enables the sound designer to go back and add sounds to this object manually, thereby ensuring that all objects in the environment are provided with sound effects.

Preferably the representation of the video game comprises, before performing the automatic analysis, a pre-identified object already associated with one or more respective sound effects, the method further comprising: determining that the identified first object exceeds a threshold level of similarity to one of the pre-identified objects; and applying one or more of the sound effects associated with the pre-identified object to the first object. The pre-identified object is an object already associated with one or more sound effects prior to the analysis of the representation by the computer. The pre-identified object could be an object that the sound designer has manually associated a sound with, for example. The analysis then bases the identification of the first object on the known identity of the pre-identified object. This is advantageous as objects and their properties can be identified based on a less detailed analysis than would be required if the environment were analysed from scratch: the object can be classified based simply on an overall similarity to the pre-identified object without requiring a full inspection.

When the first object is found to correspond to the pre-identified object in this way, it can then be either tagged with one or more properties belonging to the pre-identified object (e.g. the first object may be determined to be the same kind of wooden door as the pre-identified object) or the sound effect may be implemented, as described previously, such that it is played upon interaction with the first object by a player.

As noted above, the representation of the video game environment may be a graphical representation of the video game environment. In this case, the graphical representation of the video game environment may comprise the graphical representation of the first object. For example, the graphical representation of the video game could be a screenshot of part of the video game environment including the first object, and the properties of the first object could be identified based on this screenshot.

The invention also provides a computer-readable medium comprising instructions which, when executed by a processor, cause the processor to perform any of the methods defined above.

The invention also provides a system comprising a processor and a memory comprising instructions which, when executed by the processor, cause the processor to perform any of the methods defined above.

### BRIEF DESCRIPTION OF DRAWINGS

An example of a method in accordance with an embodiment of the invention will now be described with reference to the accompanying drawings, in which:

FIG. 1 shows an example of a video game environment suitable for use in methods in accordance with embodiments of the invention; and

FIG. 2 is a flow chart of an example of a method in accordance with an embodiment of the invention.

### DETAILED DESCRIPTION

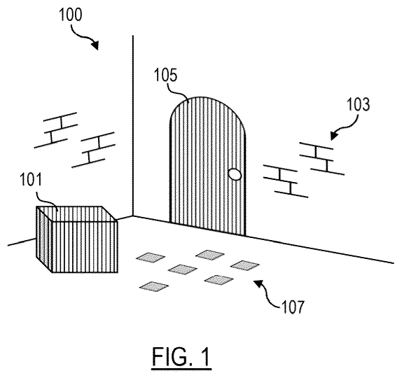

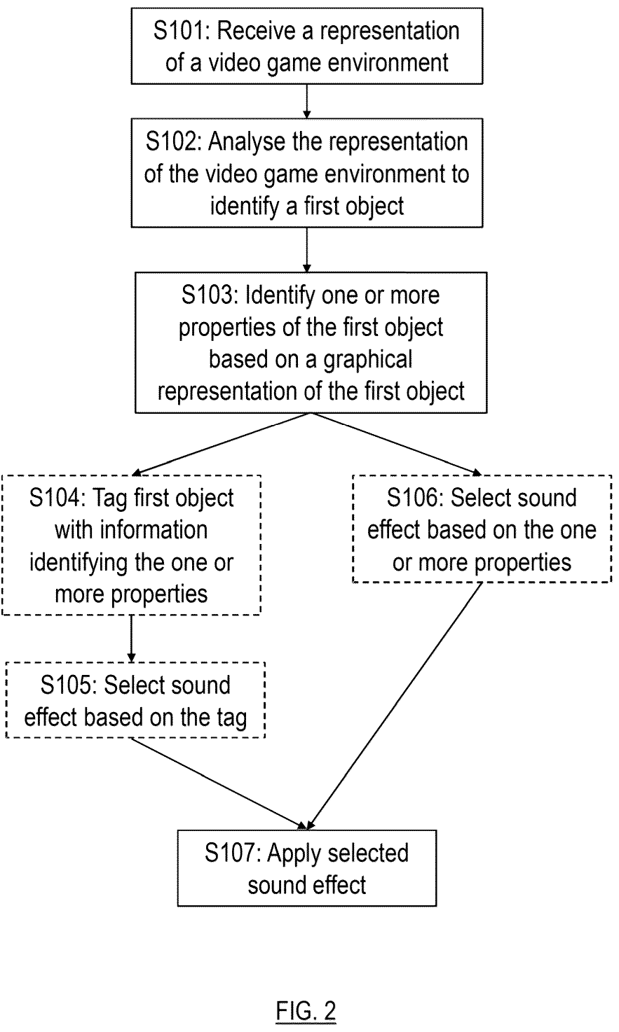

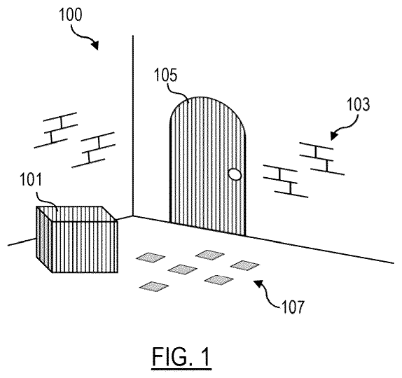

FIG. 1 shows an example of part of a video game environment 100 suitable for in methods in accordance with embodiments of the invention. The part of the environment shown here is a portion of a room, in which there is a wooden door 105 in one of the walls. The wall has a brick texture 103 and the floor of the room has a tiled texture 107. Near the door is a wooden crate 101. In this example, the environment is a three-dimensional (3D) environment.

In production, a graphical model (in this case a 3D model) of the environment will be produced by a graphics artist. The objects in the environment—e.g. the walls 103, floor 107, door 105 and crate 101—will be rendered with textures representing their materials. The player will explore the environment and interact with the objects in it during gameplay—for example, the player may control a character in the game to walk across the floor 107, break the crate 101 and open the door 105.

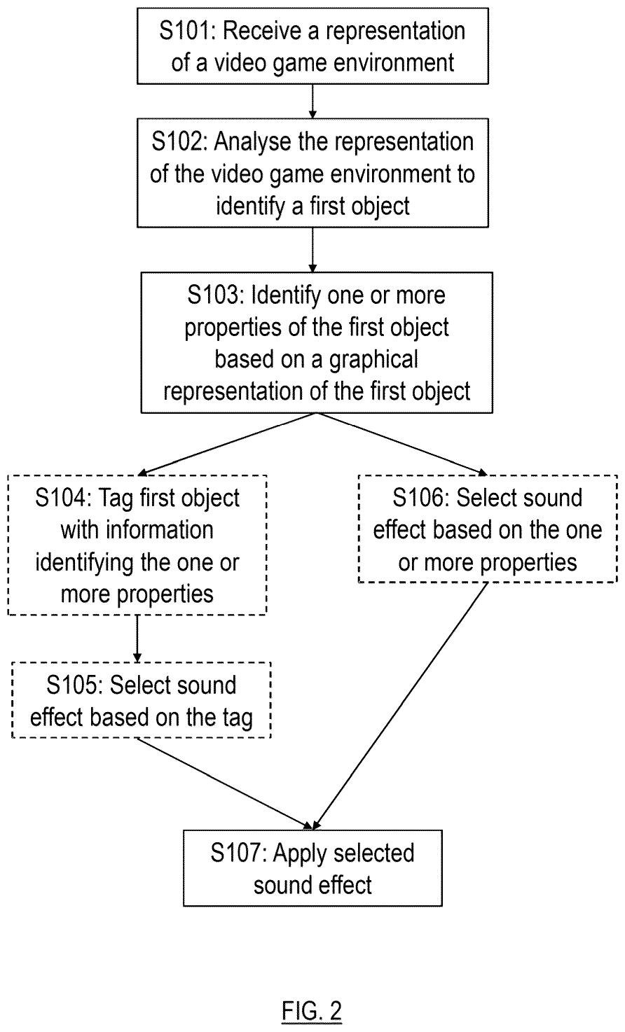

FIG. 2 is a flow chart showing the steps of an example of a method in accordance with an embodiment of the invention. Dashed boxes (steps S104-S106) indicate optional steps of the method. The steps of this method are performed by a computer, e.g. executed by a processor in communication with a memory that comprises instructions for performing the steps of the method.

In step S101, a representation of a video game environment such as the environment 100 shown in FIG. 1 is received. This representation could be the graphical model of the environment that will be implemented in the game software, or could be an image such as a screenshot of the graphical model or a sketch, mock-up or other artwork, or a non-graphical representation such as code defining the form of the environment 100.

In step S102, the representation is analysed to identify a first object in the video game environment. This is preferably performed using a computer vision algorithm, which could be trained on graphical representations of other video game environments and/or individual objects. In the example of FIG. 1, step S102 may result in the computer identifying the door 105 as a first object in the environment 100. The method then proceeds to step S103, in which one or more properties of the first object are identified based on a graphical representation of the first object. The graphical representation of the first object could be a screenshot of part of the environment 100, for example.

In the example of the door 105, the computer could identify that the door 105 has a wooden texture and therefore identify, as one of the properties of this object, that its material is wood. The computer could also identify, based for example on the shape of the door 105, that it is a door and that it will therefore perform the action of being opened and closed during gameplay. This action represents a further property of the door 105.

It will be appreciated that, while steps S102 and S103 identify a minimum of one object (the first object) and one or more properties of that object, they may identify a plurality of objects each with associated properties. For example, in the environment 100 described above, step S102 may also identify the walls 103, which have the property of being made of brick, floor 107, which has the property of being made of stone, and crate 101, which has the property of being made of wood.

Step S103 may fail to identify properties of some of the objects identified in the graphical representation. For example, the computer may identify that the floor 107 is a distinct object, but fail to identify its material. In this case, a flag indicating the failure may be output so that a sound designer can manually add suitable sounds for that object to the game environment.

For each of the identified properties of the object (in this example the door 105), one or more sound effects may be selected and implemented in the video game environment. For example, based on the fact that the door 105 is identified as being made of wood, sound effects corresponding to different interactions with the door—e.g. it being shot with a bullet or collided with by the player—may be selected. Two different ways of achieving this will now be described.

The first way of implementing sound effects is achieved by performing steps S104 and S105. In step S104, the first object is tagged with information identifying the one or more identified properties. The information could simply be a list of the properties, or some other kind of data suitable for selecting appropriate sound effects to be applied to the object. Then, in step S105, the computer may select a sound effect based on the tag—for example, a sound effect representing wood being struck by a bullet may be selected based on the fact that the tag contains information identifying the door 105 as being made of wood. Alternatively, the user (e.g. a sound designer) could review the graphical representation including the applied tags and then select, by providing suitable input, the sound effects to be applied to the first object in the game environment. The sound effect would thus be applied in response to receiving the input indicating the selection in this case.

In an alternative approach, after step S103, the method may proceed to step S106, in which the computer selects one or more sound effects to be associated with the first object based directly on the identified properties. For example, given the property of the door 105 being made of wood, sound effects associated with interactions between the player and wooden objects could be automatically selected.

In both of the cases just described (i.e. automatic selection or selection based on a tag applied to the first object), the sound effect may be selected from a sound effect library. The sound effect library comprises a plurality of sound effects, each of which may be stored together with one or more properties describing the kind of object that it represents. For example, the library could contain a sound effect representing a bullet hitting wood, which could be stored with the property “wood”, indicating that this sound effect is suitable for application to game objects made of wood.

After selecting sound effects (either based on properties listed in the tag or directly based on the one or more identified properties), the sound effect is then applied to the first object in step S107—for example, the sound effect may be added to the data files that constitute the software of the video game. This step S107 preferably comprises generating a file configured to cause the sound effect to be played in response to the player interacting with the object during gameplay.

1. A computer-implemented method of producing a video game environment, the method comprising:
receiving a representation of the video game environment;
identifying a first object in the video game environment;
identifying, based on a graphical representation of the first object, one or more properties of the first object suitable for selecting a sound effect to be applied to the first object; and
applying a sound effect to the first object in the video game environment based on the one or more identified properties.

2. The method of claim 1, wherein the sound effect applied to the first object is selected and applied automatically based on the one or more identified properties.

3. The method of claim 1, further comprising, after identifying the one or more properties of the first object, applying a tag to the first object, the tag comprising information identifying the one or more identified properties.

4. The method of claim 3, wherein the sound effect is applied to the first object in response to user input indicating a selection of the sound effect.

5. The method of claim 1, wherein the sound effect is selected from a sound effect library.

6. The method of claim 5, wherein the sound effect library comprises a plurality of sound effects and, for each of the sound effects, one or more properties associated with the sound effect.

7. The method of claim 6, wherein the sound effect applied to the first object is selected from the sound effect library based on a match between at least one of the one or more identified properties and the properties associated with the sound effect in the sound effect library.

8. The method of claim 1, wherein applying the sound effect to the first object comprises implementing the sound effect in the video game environment, wherein the sound effect is played upon interaction with the first object by a player.

9. The method of claim 1, wherein applying the sound effect to the first object in the video game environment based on the one or more identified properties comprises generating a file configured to cause the sound effect to be played in response to the player interacting with the object during gameplay.

10. The method of claim 1, wherein the identified properties comprise one or more of a material of the first object, one or more dimensions of the first object, or an action to be performed by the first object during gameplay.

11. The method of claim 1, wherein the identification of the one or more properties of the first object is performed using a computer vision algorithm.

12. The method of claim 11, wherein the computer vision algorithm is trained, prior to the identification, on graphical representations of objects other than the first object.

13. The method of claim 1, further comprising:
automatically analysing the representation of the video game environment to identify a second object in the video game environment;
detecting a failure in identifying one or more properties of the second object; and
outputting a flag indicating the failure.

14. The method of claim 13, wherein:
the representation of the video game comprises, before performing the automatic analysis, a pre-identified object already associated with one or more respective sound effects; and
the method further comprises:
determining that the identified first object exceeds a threshold level of similarity to the pre-identified object; and
applying one or more of the sound effects associated with the pre-identified object to the first object.

15. The method of claim 1, wherein the representation of the video game environment is a graphical representation of the video game environment.

16. The method of claim 15, wherein the graphical representation of the video game environment comprises the graphical representation of the first object.

17. The method of claim 1, wherein the representation of the video game environment comprises an image of the video game environment or a computer graphics model of the video game environment.

18. A non-transitory computer readable medium comprising instructions which, when executed by a processor, cause the processor to perform the method of claim 1.

19. A system comprising:
a processor; and
memory comprising instructions which, when executed by the processor, cause the processor to perform the method of claim 1.
